(19) United States
(12) Patent Application Publication
(10) Pub. No.: US 2024/0429531 A1
(43) Pub. Date: Dec. 26, 2024

(54) A MODULAR ENERGY STORAGE SYSTEM WITH INTERLOCKING STACKABLE MODULES

(71) Applicant: YOUSOLAR, INC., Santa Clara, CA (US)

(72) Inventor: Arnold Leitner, El Cerrito, CA (US)

(73) Assignee: YOUSOLAR, INC., Santa Clara, CA (US)

(21) Appl. No.: 18/707,777

(22) PCT Filed: Nov. 16, 2022
(86) PCT No.: PCT/US2022/050116

§ 371 Date: May 6, 2024

Related U.S. Application Data
(60) Provisional application No. 63/280,930, filed on Nov. 18, 2021.

(51) Int. Cl. H01M 50/258; H01M 50/264; H01M 50/517

(52) U.S. Cl. CPC H01M 50/258; H01M 50/264; H01M 50/517

(57) ABSTRACT

A modular energy storage system includes a plurality of modules removably coupled into a stack and each including electrical components that together form the energy storage system. The plurality of modules includes a lower module having a top side defining top alignment features, an upper module having a bottom side defining bottom alignment features corresponding with the top alignment features to position the upper module on top of the lower module, and wherein the upper module is stacked on the lower module and the upper and lower modules are electrically coupled.

### CROSS-REFERENCE TO RELATED APPLICATION

This application claims the filing benefit of U.S. Provisional Application No. 63/280,930, filed Nov. 18, 2021, which is incorporated by reference herein in its entirety and for all purposes.

### FIELD

The present disclosure relates generally to an electric power system, specifically a solar power system with battery storage, and more specifically to a modular system that is formed by a plurality of stackable, interlocking modules.

### BACKGROUND

Renewable energy, such as that produced by solar electrical systems, continues to gain popularity and importance in addressing the climate challenge of modern society. Because renewable energy is collected from the environment and can, thus, be cyclical or unpredictable, storage of renewable energy is essential to reducing or eliminating our need of or dependence on conventional fossil fuel-based energy sources. Significant advancement has been made in the area of renewable energy storage but further improvements in this field are needed.

In the context of solar electrical systems or other renewable energy systems, the energy is typically stored in batteries. In various scenarios, it may be advantageous to be able to store significant amount of energy, such as for residential, commercial, or field use and off-grid applications of those uses. In such cases, a cabinet-sized battery systems, which typically includes multiple batteries and associated electrical components, may be used to store and draw power, for example in an off grid scenario such as due to loss of power or when power is needed in the field where grid power is not readily available. Often such larger-capacity energy storage system is a permanent installation, installed as one big unit or in a closed electrical cabinet. More recently electrical energy storage systems made up of stackable units have been introduced to make these power systems portable, modular and thus expandable, and generally easier to install. One such system is the modular electrical system described in U.S. Pat. No. 10,524,393, titled “Multi-module electrical system containing with an integral air duct,” the contents of which are incorporated herein by reference in its entirety for any purpose. While this patented modular electrical system provides an advancement over the state of the art, designers and manufacturers of energy storage systems continue to seek improvements thereto.

### SUMMARY

An example modular energy storage system includes a plurality of modules removably coupled into a stack and each including electrical components that together form the energy storage system. The plurality of modules includes a lower module having a top side defining top alignment features, an upper module having a bottom side defining bottom alignment features corresponding with the top alignment features to position the upper module on top of the lower module, and wherein the upper module is stacked on the lower module and the upper and lower modules are electrically coupled.

Another example of a modular energy storage system includes a plurality of modules arranged into a stack. The plurality of modules includes a lower module having a top side defining top alignment features, an upper module having a bottom side defining bottom alignment features slidably and removably engaged with the top alignment features, a plurality of battery cells and electrical components disposed within the upper and lower modules, and wherein the upper module is slidably stacked on the lower module and the upper and lower modules are electrically coupled.

An additional example of a modular energy storage system includes a plurality of modules arranged into a stack. The plurality of modules includes a lower module having a top side defining top alignment features, an intermediate module including a bottom side defining bottom alignment features configured to slidably and removably engaged with the lower module, an end module, different from the either or both of the lower module or intermediate module, a plurality of electrical components disposed within the intermediate and lower modules, and wherein the intermediate module slidably engages the lower module, electrically and mechanically coupling the intermediate and lower module.

### BRIEF DESCRIPTION OF THE DRAWINGS

The accompanying drawings, which are incorporated in and constitute a part of the specification, illustrate examples of the disclosure and, together with the general description given above and the detailed description given below, serve to explain the principles of these examples.

FIG. 1 shows a perspective view of a modular electrical system according to an embodiment of the present disclosure.

FIG. 2 shows a top isometric view of one of a single module that can be stacked into the modular electrical system of FIG. 1.

FIG. 3 shows a rear left isometric view of one of the module of FIG. 2.

FIG. 4 shows a rear view of the module of FIG. 2.

FIG. 5A shows a front view of the module of FIG. 2.

FIG. 5B shows an enlarged view of the detail 5B taken at line 5B in the front view of FIG. 5A.

FIG. 6A shows a cross sectional view taken at line 6A-6A in FIG. 5A.

FIG. 6B shows an enlarged view of the details 6B at lines 6B-6B, respectively, in FIG. 6A.

FIG. 6C shows an enlarged view of the details 6C at lines 6C-6C, respectively, in FIG. 6A.

FIGS. 7-13 show a sequence of steps demonstrating the ease of installation of a module for a modular electrical system according to the present disclosure, such as the one shown in FIG. 1.

FIGS. 14A-14C show disassembled components of an example a module chassis which can provide the enclosure of the module in FIGS. 2-6.

FIG. 15 shows a top isometric view of a base module that can be used in the modular electrical system of FIG. 1.

FIG. 16 shows a bottom isometric view of a top module that can be used in the modular electrical system of FIG. 1.

The description herein will be more fully understood with reference to these figures in which components may not be drawn to scale, and which are presented as various embodiments of the present invention and should not be construed as a complete depiction of the scope of the present disclosure.

### DETAILED DESCRIPTION

A multi-module, also referred to as modular, electrical system for receiving an external energy source and delivering power to a load includes a set of individual (i.e. separable) stackable modules which contain the electronic components associated with receiving and delivering power. The set of components may include at least one, and typically a plurality of batteries or battery cells, a direct current (DC) bus, a DC-DC converter in electrical communication between the at least one battery and the DC bus, a module adding energy from one or more solar panels to the DC bus, a AC-DC rectifier adding energy from an alternating current (AC) current source to the DC bus, and an inverter adapted to generate alternating current (AC) from the DC-DC bus. These components are distributed among the different stackable modules, such that together the modules, when operatively (e.g., electrically) connected, form the multi-module electrical system.

In some embodiments, the multi-module electrical system is an energy storage system comprised of a plurality of stackable and interlocking modules that contain the electrical components for operatively associating the battery cell(s) of the multi-module system with the external energy source for storing energy from the external energy source) and/or with an external load for providing power thereto. The modular electrical system may include multiple modules implemented in accordance with any of the examples in U.S. Pat. No. 10,524,393, incorporated herein by reference in its entirety. The electronic components are arranged in the modules in a manner that further allows for the easy reconfiguration and/or expansion (e.g., increasing energy storage capacity, adding more solar power, or more power from an alternating current source, or other DC power source, or increasing the DC to AC power) of the multi-module electrical system. Further, the electrical connections and components may be hidden or otherwise configured to prevent access to the connections when the system is assembled, such configuration helps to reduce the likelihood of accidental shorts to the system, user injuries, and/or damage to the connections and components themselves.

The modules have mechanical and electrical coupling interface that enables interchangeability of the modules that further facilitates the easy reconfiguration and/or expansion of the multi-module electrical system. For example, no tools may be required to stack, mechanically secure, and connect the modules, which allows almost any user to easily assembly and install the system. The innovative packaging of these module housing enables the modules to be easily stacked and automatically secured, by virtue of stacking the modules together, in the stacked arraignment for quick and easy installation of a power storage system, such as in the field, in a residential setting, or in various other use case scenarios.

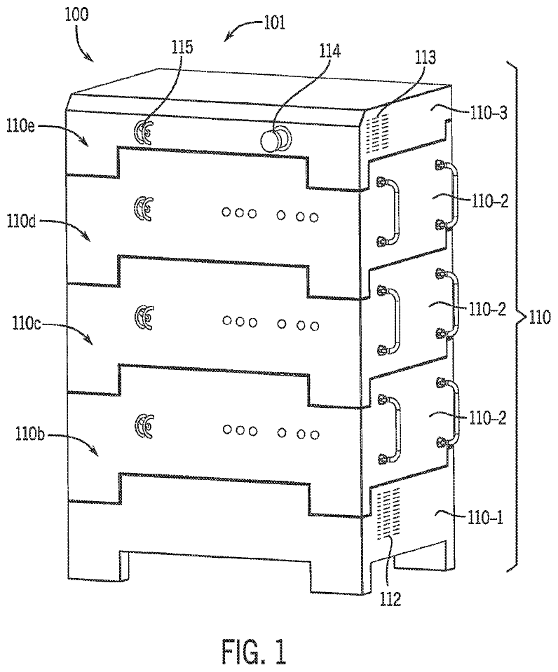

FIG. 1 shows a modular electrical system 100, and more specifically an energy storage system 100, including a plurality of modules 110 and associated electrical components (e.g., any suitable combination of transformers, converters, controllers, fans, thermal management components, wiring, batteries, etc.) that together form a functional electrical system 100 for storing and providing energy (e.g., in off grid applications). The system components associated with each module 110 are housed in a module enclosure 202 (or housing). The module enclosures 202 are configured to stack together in a nested or interlocking manner. When stacked, the modules 110 are mechanically and electrically connected thereby forming a stack or tower 101 (also referred to as a monolith) of modules 110, which forms a complete operational electrical system 100. The electrical connection between the modules 110 is achieved automatically by the stacking of the modules 110 as will be further described. Also, stacking the modules 110 may additionally result in automatically latching the modules 110 together to secure them into the stack 101 and thus reduce the risk of accidental dislodging (i.e., lateral sliding) of modules 110 from the stack 101. As can be appreciated, the modules 110 may be stacked and secured together without the use of tools.

An example stack 101 of modules 110 that form an energy storage system 100 are shown in its assembled (i.e. stacked) configuration in FIG. 1. Each of the modules 110 is separable from the stack 101. The individual modules 110 are manufactured separately and may be delivered separately to the installation site (e.g., residential building or the like). Some or all of the modules 110 contain electrical components that are substantially fully enclosed within the enclosure 202 of each module 110, as delivered to the site, and are substantially protected from the environment (e.g., from rain, wind or any other harsh weather)

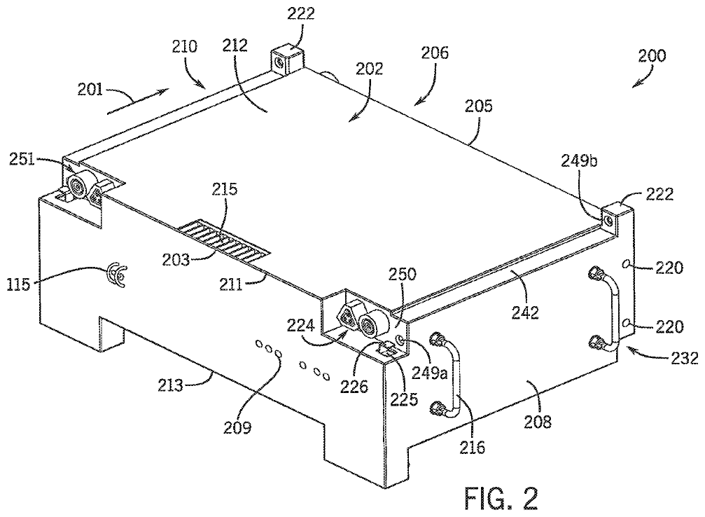

The example system 100 includes a base module 110-1, which is configured to be placed on a support surface (e.g., the ground) and which supports the rest of the modules 110 in the stacked arrangement. The base module 110-1 may be referred to as an end module. The base module 110-1 provides a stable base for the stack 101 and may be configured to elevate the stack 101 to a certain clearance (or standoff) above the ground. The base module 110-1 may include legs 434 or a base designed to provide an even surface for the stack 101, e.g., support the remaining modules 110 on the support surface. The base module 110-1 may further include leveling features to adjust a height of each of the legs 434 or the different regions of the base module 110-1 relative to the support surface. In some embodiments, the base module 110-1 may be a passive module and contains no electrical components, but in other embodiments, may include electrical components. In some embodiments, the base module 110-1 includes one or more vents 112 for an air duct (see air duct opening 203 in FIGS. 2 and 3) of the modular system. In some embodiments, the base module 110-1 simply serves as a support for the stack 101. In some embodiments, the base module 110-1 may be weighted down, e.g., by an internal mass, for added stability. In some embodiments, the base module 110-1 may include one or more electrical components or passive components, such as a heat exchanger 215 located in the air duct 203 or a fan operatively arranged to move air through the air duct and out through the vent(s) 112. The heat exchanger 215 may be a passive heat exchanger or an active heat exchanger. In some embodiments, the base module 110-1 may include one or more battery cells, thereby increasing storage capacity of the tower 101 and adding weight to the base 110-1, which can improve the stability of the base module 110-1. The base module 110-1 may include a coupling (or stacking) interface on only one side of the module 110-1, namely on the top side, for stacking the other modules 110 onto it, as shown e.g., in FIG. 8.

The system 100 may further include a top module 110-3, which is located at the top of the stack 101. The top module 110-3 may also be referred to as an end module. The top module 110-3 may include a coupling (or stacking) interface only on its bottom side (as shown e.g., in FIG. 9) and may also be referred to as a cover module or simply a cover 110-3. The top module 110-3 may contain the controller of the system 100, and as such, the top module 110-3 may be interchangeably referred to as the controller module (or simply controller) 110e. In some embodiments, one or more vents 113 are additionally provided in the top module 110-3 for the circulation of air from the exterior into the tower 101 and out through the vent 112, or possibly through similar vents in any of the modules 110-2. Fan(s) may be provided in either or both of the top module 110-3, intermediate modules 110-2, and/or the base module 110-1 to move the air through the air duct. The air may flow (e.g., responsive to the fan(s) arrangement and operation) in any direction (e.g., from top to bottom or in the reverse) through the stack 101 in the various embodiments of the present disclosure. Preferably, the air flows downward, being pulled into the tower 101 through an air intake at the top (e.g., the vent(s) 113) and is pushed out of the tower 101 through a vent outlet at the bottom (e.g., the vent(s) 112) such that any water, dirt or other debris that may be located at the base of the tower 101 are not sucked into the air duct but are instead pushed away from the tower 101. In some embodiments, one or more fans may additionally or alternatively be provided in one or more of the intermediate modules 110-2. In one example, each module 110 contains its own fan to facilitate moving the air into and through the air duct. Alternatively, or additionally, a heat exchanging system 215 may be provided in the air duct 203 to facilitate the transfer of heat energy out of the system 100. The heat exchanging system 215 may be a passive or active heat exchanging system. In some embodiments, the system 100 may be configured to be daisy-chained to another modular system 100 (e.g., a second stack 101), or to multiple such stacks 101 via one or more suitable connectors provided in at least one the modules 110, for example in the top module 110-3. The system 100 may include an emergency stop 114, which may be located in closest proximity to the controller, e.g., in this case in the top module 110-3, or on each module 110. Additionally, each module 110 may include an On/Off switch 115 for powering down the individual modules 110, which may be a prerequisite to unstacking the modules 110.

At least one, and typically a plurality of intermediate modules 110-2 may be located between the base module 110-1 and the top module 110-3. The intermediate modules 110-2 may have different heights and may, thus, provide a different internal volume. The additional intermediate module 110-2 may further increase the battery or energy capacity of the stack 101 as a whole, e.g., adding additional intermediate modules 110-2 may assist in increasing the overall capacity of the stack 101. Irrespective of the height of each intermediate module 110-2, the stacking interface of each may be substantially the same making the intermediate modules 110-2 interchangeable. That is, any of the intermediate modules 110-2 may be located at any vertical (or elevational) position in the stack 101. Also, the number of modules 110 that form the stack 101 may be easily varied, e.g., from five modules 110 in the current example, to fewer (e.g., 3 or 4) or a greater number of modules (e.g., 6, 7, or more) by simply adding additional intermediate modules 110-2. The configuration of the electronics and thus functionality of the stacked system 100 may thus also be easily reconfigurable by virtue of adding and/or removing modules 110. The modular system 100 is preferably intended to be installed as a freestanding system 101 (or monolith), and as such there may be a practical limit on the total number of modules 110 that could be stably stacked. However, in such scenarios it is envisioned that additional securement structure(s), such as a bracket or tie, may be used to secure the stack to another structure (e.g., the wall of a building), such as at attachment points 220.

Some or all of the different modules 110 may contain different components configuring them to provide a different function of the system 100. For example, one or more of the modules 110 may be configured as a battery pack 110a. At least one other intermediate module 110-2 may be configured as an inverter 110b, a rectifier 110d, and/or any additional functional unit that may be needed to connect the battery pack 110a to supply power to a home, commercial building or to any other load, and/or to be connected to an external energy source (e.g., a renewable energy source such as a solar panel system). For example, electrical components for connecting the system 100 to a solar panel system may be provided in a module 110c, also referred to here as solar input module 110c. As mentioned previously, the system controller may be provided in a separate controller module 110e, which is shows here as the top module 110-3. The internal configuration of (e.g., arrangement of components inside) the modules 110 may be implemented in any suitable manner, such as in accordance with any of the examples of the incorporated by reference U.S. Pat. No. 10,524,393.

The system 100 may employ a parallel power architecture, e.g., a 380 Volt (V) parallel bus as described in the incorporated by reference U.S. Pat. No. 10,524,393. This parallel architecture may enhance the modularity of the system 100, as it enables additional components (e.g., additional battery packs) to be easily added at different locations in the “circuit.” In an example of parallel architecture, the electrical coupling of adjacent modules 110 is achieved via sets of electrical connectors 251, 253 each located in the left and right posts 234 of the nesting/interlocking interface. In other embodiments, only a single connector set may be used per module, which may be located in either the left post or the right post 234. In other examples, the module 110 may include only a single post 234 and the single post 234 may include parallel electrical architecture with a single connector set 251, 253. As previously noted, a fan may be provided in the stack 101, for example in the bottom 110-1 (or base module) or in the top module 110-3. In some embodiments a plurality of fans, which may be co-located in the same module 110 or distributed between modules 110, such as in the top 110-3 and bottom modules 110-1, may be provided, e.g., for redundancy. The fans may be located in the air duct 203. In some examples, a heat exchanger 215 may located additionally or alternatively in the air duct 203. In one embodiment, a 24V fan is located in the top module 110-3 to push the air down, and optionally a second 24V fan may be provided, e.g., also in the top module 110-3 for redundancy. The fan(s) or heat exchanger 215 may be connected to and thus powered by the existing main bus of the system 100, which in some embodiments may be a 380 V bus. If the main bus shuts down, the system 100 may include a rechargeable battery of sufficient voltage (e.g., a 24V battery) and energy to power the fan(s) and, or heat exchanger 215 and ensure cooling of the system 100 can be completed even after the main bus shuts down. All cables of the wire bus are enclosed within the enclosures of the modules 110, which protects the electronics of the system 100 from the elements. The electrical connectors 251, 253 for connecting communication and power from one module 110 to the next are exposed at the interface, but once stacked, they are also concealed and thus protected from the elements and contact by humans or animals, thus making the system 100 (e.g., the stack of modules 101) virtually impenetrable by the elements and safe to the touch. The nested stacking arrangement of the modular system 100 described herein provides various technical and aesthetic advantages.

As will be further described, the modules 110 are configured, when stacked, to interlock (or nest) together into a complete system 100. The housing 202 of each module 110 includes a coupling (or stacking) interface, which includes mechanical and electrical coupling components that enable the interlocking of the modules 110 and the electrical connectivity of the modules as they are stacked. The stacking of the modules 110 automatically effects the electrical interconnection of the modules 110 and may also automatically secure modules 100 to the stack 101 (e.g., via an automatic latch mechanism described further below). The coupling interface of the modules 110 enables interchangeability of the intermediate modules 110-2, in that any intermediate module 110-2 can be positioned at any vertical location in the stack 101 between the base 110-1 and top modules 110-3. As such, the modules 110 may be referred to as interchangeable, which enhances the modularity of the system 100 making it easier to install and/or expand to meet a need.

FIGS. 2-6C show various views of a module 200 and an enclosure (or housing) 202 of an intermediate module 200, which may be used to implement any of the modules 110 and may be the intermediate modules 110-2 of system 100. The features described with reference to module 200 may be included entirely or partially in any of the modules 110, including the top module 110-3 or the bottom module 110-1.

As can be seen in FIGS. 2 and 3, the generally box-shaped enclosure 202 of module 200 has a front side provided by front panel 204, a rear side provided by rear panel 206, left and right sides provided by panels 208 and 210, respectively, and top and bottom sides provided by the top and bottom panels 212 and 214, respectively. The enclosure 202 may be formed from one or more sheets of metal folded to form the shape of the enclosure. Within the enclosure, each module 200 may include a vertical frame 219 that supports the weights of the modules 200. Because the vertical frame 219 supports the load, the enclosure 202 may be a made from a thinner or cheaper material. In one example, the panel 204 includes penetrations 209 for at least one of button and/or light indicator of the module 200 is referred to, arbitrarily and for illustration only, as the front panel 204, which may be the panel that the user is facing when stacking the modules 110. However this designation is arbitrary (provided for illustration only) and does not change the operation of the invention 100. In other words, the front and rear designations can be interchanged in other embodiments without changing the operation of the invention. In some embodiments, and except for the penetrations 209 in the front panel 204 (e.g., for the various buttons and/or indicators), the enclosure 202 may be substantially symmetric about one of the vertical mid-planes, in this example, about the vertical mid-plane that extends from the front to the rear side of the module 200.

The upper and lower sides of the module 200 may include a combination of coupling components that are the same in each intermediate module 110-2 making these modules 110-2 interchangeable. For example, the modules 200 may define posts 222, 234, or extensions, extending vertically from a side of the modules 200, and recesses 224, 232, or slots, having a sufficient width and depth to receive the posts. A pair of first vertical posts 222 may extend from the upper side of the enclosure 202. In the present example, the first vertical posts 222, or rear posts 222, are located at the rear corners, along the upper rear edge 205 of the enclosure 202. A pair of first recesses 232, or rear recesses 232, may be defined on the bottom side of the enclosure 202 at corresponding locations, for example at the two rear corners along the lower rear edge 207. The first recesses 232 of one, for example an upper module 200, are each sized to accommodate, and thereby nest with, a corresponding one of the first vertical posts 222 of another, for example lower module 200 located immediately below the upper module 200. In some embodiments, the first vertical posts 222 and the first recesses 232 are sized such that a post 222 are substantially fully received/accommodated within the corresponding recess 232 whereby the side and rear surfaces of the enclosure 202 are substantially flush when the modules 200 are stacked, provide a substantially smooth or continuous profile, giving the impression of a monolithic structure 101. The profile of the stack 101 may reduce or limit the amount of fluids, particles, objects, plants, or animals that may intrude into the system 100.

On the front side of the module 200, a similar nesting may occur between a pair of second recesses 224, or front recesses 224, of a lower module 200 and a pair of second vertical posts 234, or front posts 234, of an upper module 200. The second recesses 224 are provided, in this example, at the two front upper corners, along the front edge 211, while the second vertical posts 234 are provided on the lower side of the module 200 at corresponding locations, namely at the two lower corners along the lower edge 213. When the modules 200 are stacked, each second vertical post 234 of an upper module 200 is received (or accommodated), in this example substantially fully, within a respective second recess 224 of a lower module, providing a substantially flush outer surface of the stack 101 when the modules 200 have been assembled.

As will be described in further detail below, installation (e.g., stacking) of the modules 200, 110 involves placing an upper module 200 onto a lower module 200 such that the two modules 200 are substantially laterally aligned and most of the weight the upper module 200 rests on the lower module 200, followed by sliding the upper module 200 relative to the lower module 200 in the coupling direction, in this example rearward, towards the first vertical posts 222, as indicated by arrow 201. For the purposes of this illustration, the term lateral refers to the width direction, which is the direction extending between the two side panels 208 and 206. The depth direction, which is also indicated by arrow 201, is the direction between the front panel 204 and rear panel 206. Either of the depth and the width direction may be referred to as the horizontal direction. The height direction is the direction between the bottom panel 214 and the top panel 212, and may be referred to as the vertical direction.

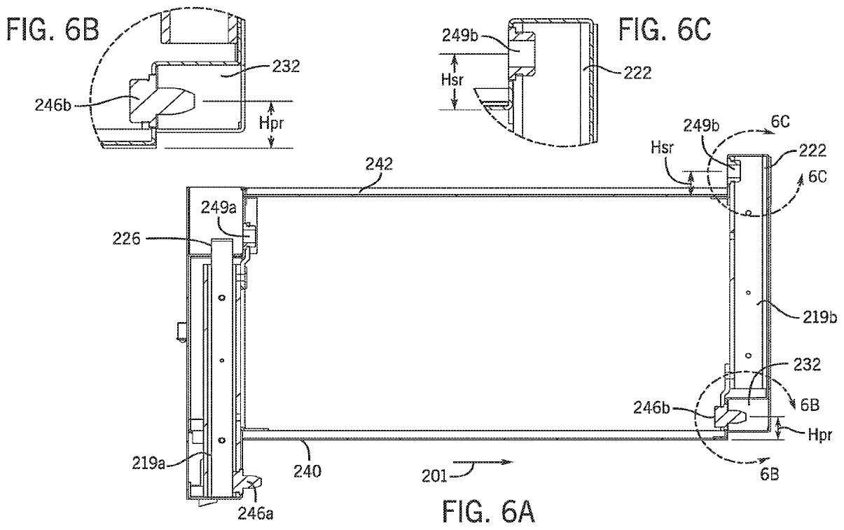

The weight of the modules 200 may be supported by vertical frames 219 within the housing 202 of the modules 200. The vertical frames 219 may be located within the housing of all modules 110. The vertical frames 219 may include beams oriented vertically, that is in the vertical direction, and extending from at or near the top of the module 200 to the bottom of the module 200. The beams may have a rectangular cross section, or a variety of different shapes sufficient to support a load in the vertical direction. As shown in FIG. 6, the vertical frames 219 may be located within the enclosure 202 and extend from each of the posts to the recesses of the modules 200. For example, rear beams 219b may extend from the first vertical posts 222 to the first recesses 232 or front beams 219a may extend from the second recesses 224 to the second vertical posts 234. The vertical frame 219 generally supports the weight of the modules 200, 110 in the height direction while the housing 202 may be sufficiently rigid to support horizontal forces, such as in the depth or width direction. In some examples, the vertical frame 219 may include additional beams that may link each or one of the front 219a or rear 219b beams together to assist in supporting horizontal forces.

The mechanical coupling (or interlocking) between adjacent stacked modules 200 further involves the insertion of load bearing pins 246 into load bearing sockets 249 (e.g., bushings). The pins 249 may act as structural supports extending from the module 200. The sockets 249 may be apertures defined by the modules 200. The pins 246 may generally have a rectangular or circular cross section. The pins 246 may also taper as they extend outward from the module 200. The sockets 249 may have a similar shape to the pins 246, such as a rectangular opening for a rectangular pin 246. The sockets 249 may have an interior perimeter greater than or equal to the exterior perimeter of the pins 246. Each module 200 may include a pair of front pins 246a configured for insertion into a pair of front sockets 249a and a pair of rear pins 246b configured for insertion into a pair of rear sockets 249b. In some examples, the pins 246 may be located on one of the upper or bottom sides while the sockets 249 may be located on the other and opposite side. For example, the front pins 246a may be provided in the second vertical posts 234 and the rear pins 246b may be provided in the rear recesses 232. The front sockets 249a may be located in the second recesses 224, located at the front of the module 200, while the rear sockets 249b may be in the first vertical posts 222 at the rear of the module 200. In some embodiments, the pins 246 are located in the recessed portions, while the sockets 249 are located in the protruding portions and recesses of the housing 202. That is, the front pins 246a are provided in the front recesses 224 and the rear pins 246b are provided in the rear recesses 234. The front sockets 249a are located in the second vertical posts 234, located at the front of the enclosure 202, while the rear sockets 249b are in the first vertical posts 222 at the rear of the enclosure 202. The pins 246 and sockets 249 may be inserted or drilled into the housing 202 and vertical frame 219 to overcome any variations in the dimensions of the housing 202. The pins 246 and sockets 249 may be located after assembly of the housing 202 in its entirety or after portions of the housing 202 are assembled. The locations of the pins 246 and sockets 249 may be adjusted for each module 200 or enclosure 202 or to accommodate known ranges in tolerances of the enclosures 202. In other examples, the pins 246 and sockets 249 may be formed in a combination of the housing 202 or the vertical frame 219. For example, as shown in FIG. 6, the front pin 246a and the rear socket 249b may be formed in the vertical frame 219 and the front socket 249a and the rear pin 246b may be formed in the housing 202 but connected to an extension of the vertical frame 219. In another example, a rear pin 246b may be formed in the housing 202, while the front pin 246a extends from the vertical frame 219. Similarly, the front socket 249a may be formed in the housing 202 while the rear socket 249b may be an aperture of the housing 202 aligned with an aperture in the vertical frame 219.

In examples where the pins 246 are on one side and the sockets 249 on another, the pins 246a, 246b may generally be oriented in the same direction, such as towards the rear panel 206, and the sockets 249a, 249b may generally face the opposite direction, such as towards the front panel 204. Stacking and aligning the modules 200 may be accomplished by moving the upper module 200 in a single direction relative to the lower module 200. Locating the pins 246 near the bottom side and the sockets 249 near the top side may assist in aligning the modules 200. It is also envisioned that in other embodiments, the locations of the pins 246 and sockets 249 may be adjusted with the pins 249 being in the recesses 224, 232 and the sockets located only in the protruding structures 222, 234, or with the pins 246 being located near the top side and the sockets 249 located near the bottom side. In examples, where the pins 246 are provided in the recessed portions, placing the pins 246 in the recessed portion 224, 232 reduces the risk of them being accidentally damaged, e.g., during transport. However, it is also envisioned that in other embodiments, the locations of the pins 246 and sockets 249 may be reversed with the pins 246 being in the protruding structures and the sockets 249 located in the recesses, or a combination of these two configurations may be used. The axes of the pins 246 and sockets 249 are orientated substantially horizontally, or laterally, such that once the pins 246 are engaged into the sockets 249 separation of the modules 200 by purely lifting a module 200 in the vertical direction is prevented.

When the pins 246 are received in the sockets 249, the pins 246 and the sockets 249 may support the weight of the modules 200 in conjunction with the vertical frame 219. The pins 246 and sockets 249 may be sufficiently rigid to further prevent twisting of the modules 200 with respect to one another, such as in the depth or width directions. The engagement of the pins 246 into the sockets 249 provides the fine alignment of two stacked modules 200 that also facilitates the automatic alignment and coupling of the electrical connectors 251, 253, as further described below. For example, the pins 246 and sockets 249 may align the electrical connectors 215, 253 such that the features of the electrical connectors 251, 253 may engage or connect.

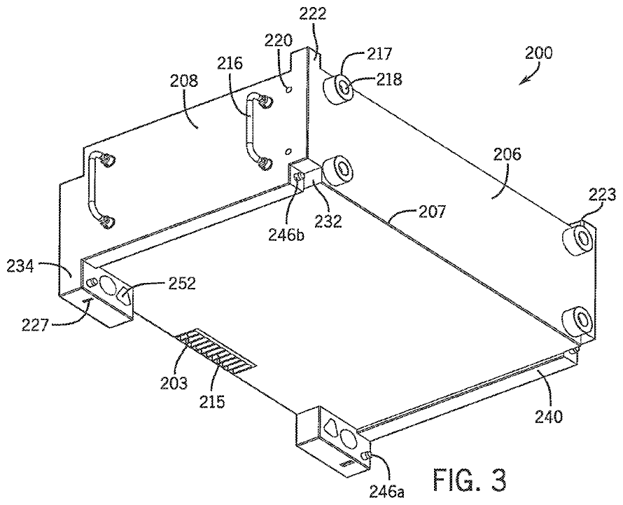

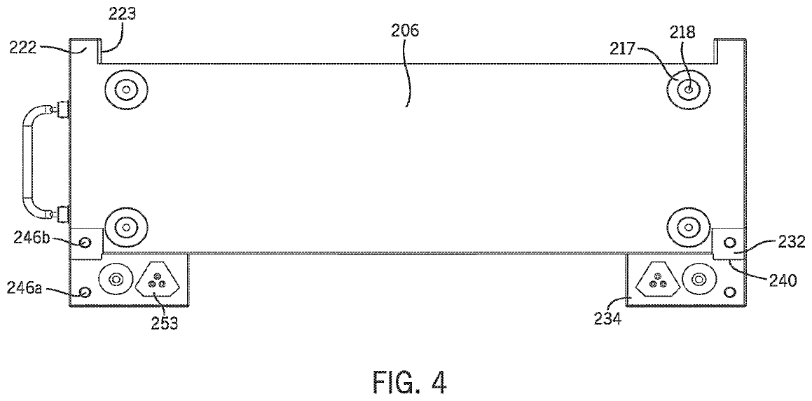

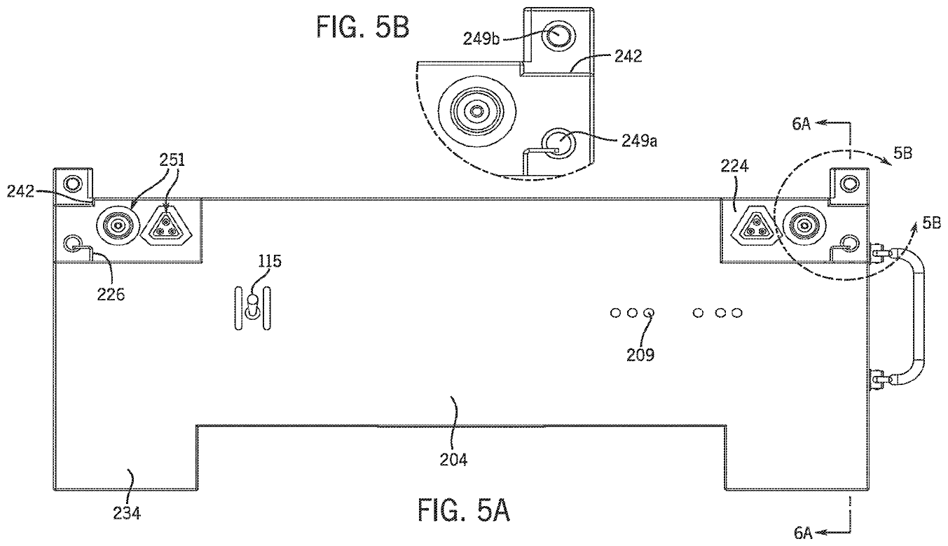

Referring to FIG. 6A-C, each of the front and rear pins 246 may be installed at a height (H_{P}) above the relevant surface which is slightly less than the height at which the corresponding socket 249 is installed such that when a pin 246b is inserted into the respective socket 249a the two relevant surfaces do not contact. For example, the rear pin 246b is installed at a height (H_{Pr}) above the outer surface of the bottom panel 212. The rear socket 249b is installed at a height (H_{Sr}) above the outer surface of the top panel 214, which is slightly greater than the height H_{Pr} (e.g., H_{Sr} may be about 0.1-0.2 mm greater than H_{Pr}). The front pin 246a and socket 249a may be similarly installed at slightly different heights such that insertion of a front pin 246a into a front socket 249a results in the same or substantially similar amount of lift at the front as produced in the back to keep the modules 200 relatively level, or horizontal, when stacked. In some embodiments, the pins 246 and sockets 246 may be aligned, horizontally, or laterally, relative to each other as shown in FIG. 5 and in some embodiments, the front 246a and rear 246b pins and sockets 249 may also be aligned vertically relative to each other, as can be seen in in FIG. 5B, which shows a front socket 249a aligned vertically with rear socket 249b, and similarly in FIG. 4, which shows a rear pin(s) 246b vertically aligned with respective front pin(s) 246a. By installing the sockets 249 at a relative height that is slightly greater than that of the pins 246, and thus providing a slight gap between the modules 200, the risk of binding of the individual modules 200 while being installed is substantially reduced or eliminated. Binding may occur if the connections between modules 200, such as between the pins 246 and the sockets 249, are in relatively close contact with the surfaces of the modules 200 and the modules 200 are no longer able to slidably connect or slidably disconnect. For example, if there is grit on any of the sliding/contacting surface (e.g., the cooperating rails 240 and/or grooves 242), if any paint or other coatings applied to these contacting surfaces varies in thickness, or if the thermal expansion of the walls of the enclosure 202 differs from that of the vertical frame 219, then any such thin layer of grit, paint, or thermal addition may result in misalignment of the pins 246 and sockets 249 if they were positioned at the same height above the relative surface. With the height difference, and thus effected lifting of the module 200 through the insertion of the pins 246 in the sockets 249, such binding is substantially avoided. As a result, the height differences between surfaces of the modules 200 and the pins 246 and sockets 249 may allow for easier assembly and disassembly of the stack 101 of modules 200.

Each module 200 is further provided with alignment features or guides, shown here as cooperating rails 240 and grooves 242. The alignment features or guides may also include the posts 234 and 222, as well as the recesses 224 and 232. The guides may generally constrain lateral movement of each module 200 relative to another module 200 to a single direction, such as in a sliding direction 201. For example, the guides may prevent movement in the width direction and only allow movement of the modules 200 in the depth direction. By limiting the directions the modules 200 may move relative to one another, assembling the modules 200 into a stack 101 may be accomplished easily and with a high degree of accuracy. The alignment features may act to constrain movement both prior to or after securing the pins 246 into the sockets 249 of a first module 200 into a second module 200.

Some or all of the alignment features may generally extend in the sliding direction of the modules 200. The rails 240, which protrude above the minimal surface of a given panel, are configured to be received at least partially within a corresponding groove, or channel, 242 to facilitate alignment and slidably coupling an upper module 200 to a lower module 200. In the illustrated example, the rails 240 are provided on the underside of the enclosure 202 while the grooves 242 are on the upper side of the enclosure 202. For example, the rails 240 may be formed in, or adjacent to, the bottom panel 214 and the grooves 242 may be formed in, or adjacent to, the top panel 212. However, the location of the rails 240 and the grooves 242 may be reversed in other embodiments such that the rails 240 are on the top side of the enclosure 202 while the grooves 242 are on the underside. In some embodiments, a combination of one or more rails 240 and grooves 242 may be provided on each of the upper and lower sides of the module 200. The guides (e.g., rails 240 and grooves 242) are aligned with the sliding direction 201, which in the present example may be the depth direction 201. In other embodiments, the sliding direction may be different. For example, in an embodiment in which the first posts 222 are arranged along one of the lateral sides of the module 200 and the second posts 234 are arranged along the opposite lateral side, interlocking of the modules 200 may involve sliding the module 200 laterally, from the side of the second posts 234 to the side of the first posts 222. In such embodiments, the guides would be aligned along the width dimension of the module 200 (e.g., along the front edge, the rear edge, and/or anywhere in between). Any suitable number of rail 240 and groove 242 pairs, fewer or more than illustrated, may be used in various embodiments. The guide surfaces, which are the surfaces of the guides which contact during the sliding coupling of the modules 200, may be coated or otherwise provided with any suitable material (e.g., Teflon or other friction reducing material) to reduce the wear on the guide surfaces and/or increase the ease of sliding the upper module 200 into engagement. In some embodiments, the depth of the grooves 242 is slightly less than the height of the rails 240 to ensure that only the guide surfaces are in sliding contact when the two modules 101 are being coupled. Further, the depth of the grooves 242 and the height of the rails 240 may be such that when the pins 246 and received in the sockets 249 and an upper module 200 is lifted relative to a lower module 200, sides of the alignment features may contact to prevent movement in a direction other than the vertical and sliding directions. The multiple contact surfaces, e.g. the alignment features and, or the pin and socket connections, may give the stack 101 torsional rigidity such that movement of one module 200 to another module 200 is effectively constrained to the sliding direction.

Each module 200 includes at least one male electrical connector 251, or a first electrical connector 251, and a female electrical connector 253, or second electrical connector 253, for transmitting power and communication signals along the stack 101. In some embodiments, the system 100 employs a parallel electrical architecture and two sets of male 251 and female connectors 253 are provided in each module 200 (e.g., as shown in FIGS. 5A and 6A). Using two sets of connectors 251, 253 can be advantageous not only for facilitating a parallel architecture but also to reduce the total number of pins needs in each connector. The electrical connections 251, 253 generally include metallic pins surrounded by insulated sleeves, such as a plastic molding. The insulated sleeves may facilitate in aligning or connecting the electrical connections 251, 253. The components of the electrical connections may be generally soft and unsuited to supporting the weight of the modules 200. The electrical connectors 251, 253 are provided at opposing faces of the coupling interface, such as at faces that nest together during the stacking process, whereby the connectors 251, 253 become concealed once the modules 200 are stacked together and are thus protected from the elements and contact by humans or animals. The opposing faces may generally be spaced from a panel or side of the module 200, such that even a side of the connectors 251, 253 are not accessible when the modules 200 are in a stack 101. In one example, the male connector(s) 251 are located in the recessed portions of the module 200, each located in a respective one of the second recesses 224, and each exposed through a respective connector aperture 250 formed in a vertical face of the recess 224. The female connector(s) 253 are located in the protruding portions of the module 200, for example located in a respective one of the second vertical posts 234, and each exposed through a respective connector aperture 252 formed in a vertical face of the post 234. In other examples, the locations of the male connectors 251 and the female connectors 253 may be reversed such that the male connectors 251 are on the protruding portions of the module 200.

The connectors 251, 253 are preferably vertically aligned and provided in the vertical faces which may minimize any load (e.g., weight of the module 200) being carried by the connectors 251, 253, which are typically not load bearing components. Further, the connectors 251, 253 may be oriented to face in a direction parallel to the sliding direction. For example, the connectors 251, 253 may generally extend along a face of the module 200 in the height or vertical direction and with the pins and plastic molding extending parallel to the depth direction. Vertically aligning the connectors 251, 253 may prevent liquid from pooling on or near the connectors 251, 253, reducing the risk of an electrical short or corrosion of the connectors 251, 253. This may be beneficial given that the concealed nature of the connectors 251, 253 may limit or prohibit inspection of the connectors 251, 253 during use. Vertically aligning the connectors 251, 253 to connect in the sliding direction may also reduce or eliminate vertical loads on, or supported by the connectors. Reducing the vertical load on the connectors 251, 253 and the constrained movement of the modules by the alignment features may allow for better contact between the electrical connectors 251, 253 and reduce the likelihood of damage to the connectors 251, 253. However, it is also envisioned that in some embodiments, the connectors 251, 253 may be on a horizontal face of the respective structure, such as the horizontal surface of either the recess 224 or post 234.

Precise alignment of the modules, and thus of the connectors to enable operative coupling of the connectors 251, 253, is achieved through vertical frames 219 as well as or in addition to the pin 246 and socket 249 engagement. That is, the vertical frame 219 and pins 246 and sockets 249 may be aligned with high tolerances relative to the male 251 and female 253 connectors to provide precise alignment of the connectors 251, 253 as a result of the insertion of the pins 246 into their respective sockets 249. Thus, the pins 246 and sockets 249 may support the entire vertical load so that little to no load is experienced on the electrical connections 251, 253. This arrangement may allow, in some examples, softer but more conductive metals or rubber molding to be used for the electrical connectors 251, 253. Also, the pin 246 and socket 249 pairs, as previously described, are located on the module 200 such that they effect a slight lifting (e.g., on the order of 0.003 to 0.007 inches, preferably between 0.004 to 0.0065 inches, or in some cases around 0.0055 inches) of the upper module 200 above a lower module 200, thereby ensuring that the load is carried by the vertical frame 219 provided by the pins 246 and sockets 249 rather than by the sheet material from which the enclosure 202 may be formed or the electrical connections 251, 253.

As can be seen throughout the figures, components at the interface which are designed to effect to interlocking and connection between the modules 200, such as the electrical connections 251, 253, may be located on surfaces that are ultimately concealed or enclosed once the modules 200 are assembled into the stack 101, thereby enhancing the aesthetics of the system 100 as well as functionally protecting these components from the environment and contact by humans or animals. When the modules 200 are fully assembled into a stack 101, the energy storage system 100 provides the aesthetically pleasing appearance of a free-standing monolithic structure 101, also providing the various technical advantages described herein.

The modules 200 may further include one or more handles 216. The handles 216 may be included on every module 200 in a stack 101, or only on some of the modules 200 in the stack 101. The handles 216 may extend from or connect to the module 200 on surfaces that are exposed when the modules 200 are arranged in stack 101. For example, the handles 216 may generally be located on the right or left sides of the module 200. The handles 216 may assist a user lifting or aligning an upper module 200 onto a lower module 200 as well as sliding a module 200 into place. The module 200 may define apertures for the handles 216 to connect or secure to the module 200. The apertures may be located on one or more of the panels. Apertures not selected to receive a handle 216 may receive a spacer 217 or a similar feature, which may be an elastic, non-slip material, such as rubber. The spacer 217 or rubber extension may allow the module 200 to be set on a surface without a panel contacting the surface. The handles 216 may be placed in each of the apertures or only one of them. The edges of the modules 200 or enclosure 202 may be chamfered to allow for better and safer grip on the modules 200 during stacking.

As shown in FIGS. 2 and 3, the modules 200 may be provided with a latching mechanism including a lever 226 and a latching aperture 225, which secures the modules 200 from inadvertently sliding out of engagement and which may also provide an audible and/or tactile feedback (e.g., a click) when the modules 200 have been properly coupled and latched. For example, the latching mechanism may, in combination with the pin 246 and socket 249 pairs and the alignment features, constrain movement of each module 200 within the stack 101. The latching mechanism may be implemented by a lever 226 that extends generally vertically between a second recess 224 and the corresponding second vertical post 234 of the module 200. In some embodiments, the lever 226 may be configured to be actuated by a user once a module 200 is in place. For example, the lever 226 may protrude slightly above the recessed horizontal surface of recess 224. The lever 226 and the latching aperture 225 may be connected to or integrated with the internal frame 219. Once an upper module 200 is installed, the upper module 200 may press the lever 226 down and actuate it into engagement with a latching aperture 225 in the horizontal surface of a lower module 200, which latches the upper module to the lower module. This latching prevents removal of any lower module 200 without first removing the upper module 200. In some embodiments, the lever 226 may be configured to be automatically latched, such as by being biased downwardly such that it would automatically click into engagement (i.e. latch) when the upper module 200 is pushed into position (e.g., as shown in FIGS. 8-13). An end module, such as a top module 110-3, may include a latch or latch release that must be engaged or disengaged to allow each latching mechanism of each module 110 to be released. When disengaged, the module 110 may be slide from the stack 101 in the reverse of the sliding direction. The latch or latch release may be mechanical or electromechanical. In some embodiments, a pair of latching levers 226 are provided in each module 200, one located at each of the two front recesses 224. In other embodiments, only a single latching lever 226 may be used.

The modules 200 may further include one or more wall spacers 217. The wall spacers 217 may be located on a side selected to be the rear of the module 200 or against a wall of a building. The wall spacers 217 may prevent heat from the modules 200 from damaging a wall, isolate the wall from the vibrations or heat from the components of the system 100, or may act to protect the modules 200 from rough surfaces of the wall. The wall spacers 217 may further define an aperture 218 configured to receive some external feature. For example, the aperture 218 may receive a rod or tie down to further secure a modules 200 position relative to a wall, for example to prevent the stack 101 from tipping.

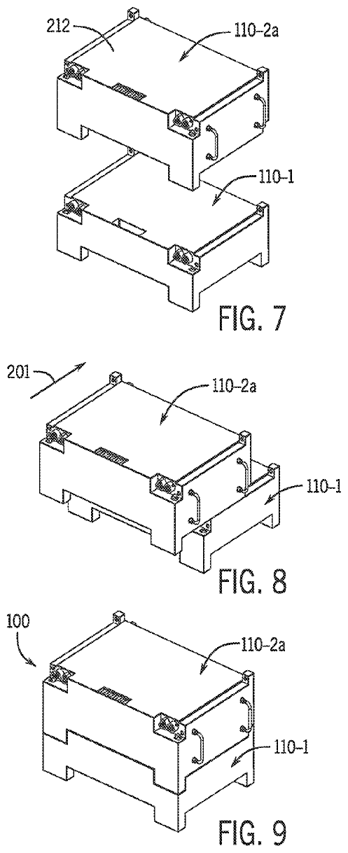

The stacking of the modules 110 is now further described, also with reference to FIGS. 7-13, which show various images taken during the stacking process to illustrate the ease with which the modules 110 can be stacked into a tower 101. As previously discussed, the features of module 200 may be incorporate into the each or some of the modules 110. Referring to FIG. 7-13, the user may wish to stack a plurality of intermediate modules 110-2, three of which are shown in FIG. 13. As can be seen in these images, the modules 110 may be sized such that they can be handled by one person. For example, the width of a module 110 may be anywhere from about 15 inches to about 25 inches, preferably modules 110 designed for single-person installation would not exceed about 30 inches in width. As mentioned before the height of the modules 110 may vary, but the height and depth of each module 110 may typically be less than the width of the modules 110. For example, the height of the modules 110 may range from about 5 inches to about 13 inches. The depth of the modules 110 may be anywhere between 12 inches to about 18 inches. An example controller and battery modules 110 may each be about 24 inches wide and about 16 inches deep, with the battery module being about 10 inches tall, excluding the height of the posts, and the controller module being about 5½ inches tall. Depending on the specific combination of modules 110 and their relative sizes, a fully assembled system 100 (or stack 101) of 5-6 modules may have a total height of about 3 feet or more (in some cases a stack may be up to 5 feet tall as additional modules are added). An individual module 110, once fully assembled with all electronics inside, would typically weigh no more than 100 lbs., and a number of the modules 110 would weigh less than, sometime significantly less than 100 lbs. These dimension and weights are given solely for illustration of scale of some embodiments of the present disclosure. It will be understood that the interlocking, stackable architecture may be used with towers 101 that are significantly larger (e.g., the individual modules 110 are larger and may be designed to be handled by two people or more) or towers 101 that are smaller. These example dimensions and weights are, thus, not intended as limiting on the scope of the present disclosure.

Referring to FIG. 7, with the first module 110-1 already installed, the user may then select a second module 110-2a to be stacked over the first module 110-1. The user aligns and places the second module 110-2a on the first module 110-1, as shown in the image in FIG. 8, by grasping designated handling areas of the enclosure, such as the handles 216 or the chamfered edges, and in some cases the recesses 232 and 222. In other examples, the handles 216 or one of the first posts 222 and one of the second posts 234. One or more of the corners of these posts may be rounded or chamfered (see chamfer 223 of the upper posts 222 in FIGS. 3 and 4) to make the handling areas more comfortable for a user to grasp. Each module 110 may be stacked by, first, placing the upper module (110-2a in FIG. 8) onto the lower module (110-1 in FIG. 8) to unload most of the weight of the module 110-2a onto the partial stack 101 already formed. The alignment guides, e.g., rails 240 and grooves 242, facilitate self-alignment, for example in the lateral direction, of the modules 110. By self-alignment it is generally implied that the user need not use any additional tools or care to keep the two modules 110-1, 110-2a laterally aligned. The two modules 110 are automatically laterally aligned during the sliding step by virtue of the alignment guides. With the upper module (110-2a in FIG. 8) seated onto (i.e. with the guides nested), and thus laterally aligned to, the lower module (110-1 in FIG. 8), a user can slide the upper module 110-2a towards the rear of the stack 101 (as shown by the arrow) to engage the pins 246 and sockets 249 and automatically electrically connect the two modules 110-1, 110-2a, as shown in FIG. 9. The vertical frames 219 of the modules 110 may slidably connect such that the lower module 110-1 vertical frame 219 may support the frame of the upper module 110-2a. The pins 246 may thus aid in the fine alignment of the two modules 110 for the connectors 251, 253. Due to slightly different heights between the pins 246 and the sockets 249 previously described, a user may need to slightly lift the upper module 110-2a to connect the upper module 110-2a to the lower module 110-1. The lift may also will accomplished by the kinetic energy of a module 110 moving in the sliding direction 201 and by the taper of the pins 246 defining a first upward sliding surface, and the sockets 249 providing a second upward sliding surface, where the sliding surfaces translate the movement in the sliding direction 201 into a vertical lift. Thus, the taper of the pins 246 may not only facilitate mating of the apertures of recess 249 and pin 246, but also creates the upward sliding surface, or ramp, that effects the lift. In some embodiments, the connectors 251, 253 may include plastic portions that surround the electrical leads, which may alternatively or additional aid the alignment and coupling of the connectors 251, 253. In some embodiments, these plastic portions of the connectors 251, 253 and/or their installation to the module 110 may provide a somewhat pliable structure (e.g., where the connectors in effect “float” in an operable position for engagement) which may further facilitate alignment and avoid the risk of damage of any components. Because of the pliability of the connectors 251, 253, a connector can “float” and thus can slightly bend down/up, right/left to engage the cooperating connector, which can further reduce the risk of the connector engagement binding, interfering with, or otherwise causing misalignment to the engagement of the pins and sockets. The user does not need to manually handle the connectors 251, 253 to couple them. When the upper module (110-2a in FIG. 9) has been installed onto the stack 101 (e.g., above module 110-1), the outer peripheral surfaces of the modules 110 (e.g., of the sidewalls of the enclosures) are substantially flush providing an aesthetically and functionally improved arrangement.

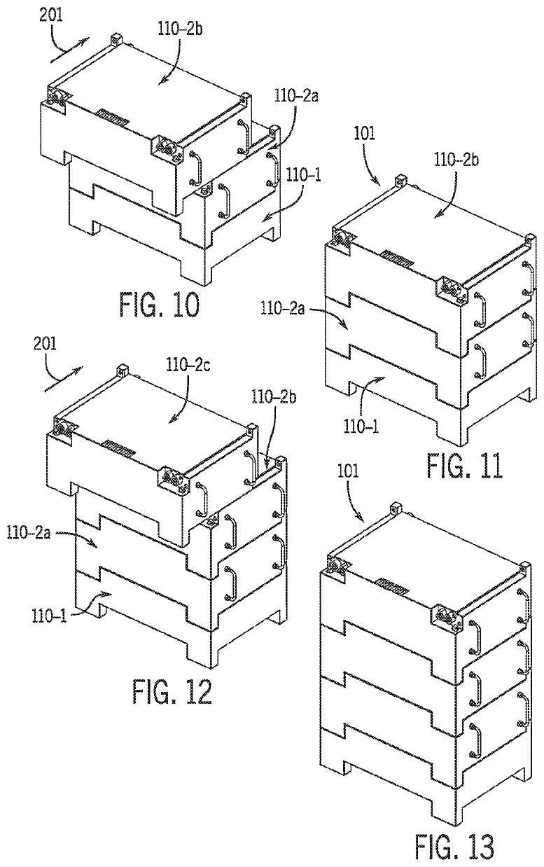

The user may wish to stack additional modules 110, and continuing with reference to FIGS. 10-13, images from installation of a third module 110-2b and a fourth module 110-2c are shown. As previously described, a user may align and place the upper module, 110-2b in FIG. 10, and 110-2c in FIG. 12, onto an already installed lower module such that the two modules are roughly aligned as dictated by the nesting of the rail(s) 240 and groove(s) 242. At this point, the upper module is slightly misaligned in the front-to-back direction but is mostly aligned in the lateral (i.e. side-to-side) direction as can be seen in FIGS. 10 and 12. The user may complete the fine alignment and coupling of the modules 110 by simply sliding the upper module (110-2c in FIG. 12) along the guides of the lower module (110-2b in FIG. 12) until the upper module is similarly flush with the rest of the stack 101 (see FIG. 13).

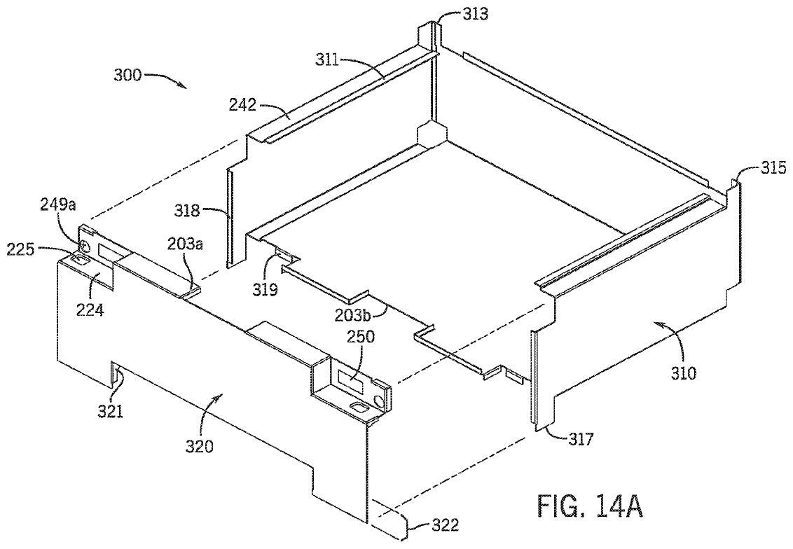

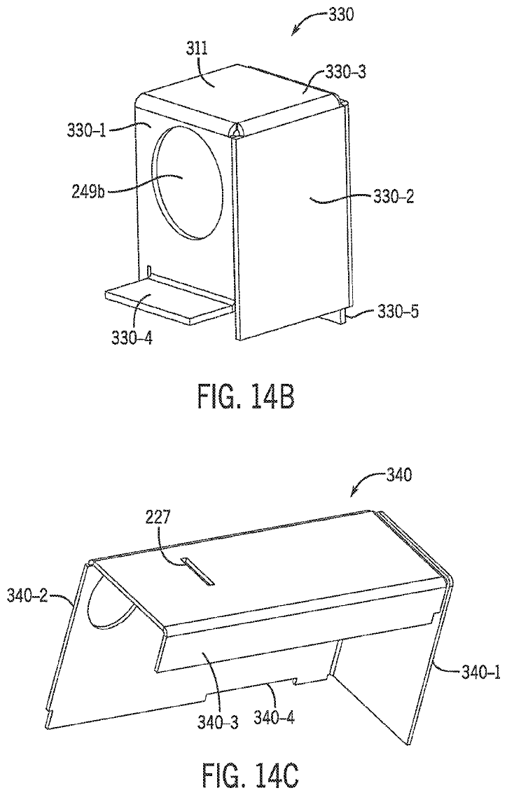

Each module enclosure 202, or chassis 300, can be manufactured relatively easily and cheaply. For example, the enclosure 202 may be made of thin sheets of material, such as sheet metal. Sheet metal of any suitable material (e.g. aluminum, steel, etc.) or any suitable thickness (e.g., 16 gauge, 18 gauge, etc.) may be used in various examples. FIGS. 14A-14C show isometric views of chassis components, which when assembled may provide the enclosure (or chassis) 300 of a module according to the present disclosure (e.g. module 200 of FIG. 2). The vertical frame 219 may be inserted into the chassis 300 and may allow for the use of the thin sheets of material. For example, the vertical frame 219 may be made with high tolerances that account for any variations in tolerances of the chassis 300. The majority of the side, rear and bottom walls of the chassis 300 may be made from a single sheet metal part, or from multiple pieces rigidly joined (e.g., welded) together to form the rear chassis portion 310, e.g., the sheet may be folded into the desired configuration. When the chassis 300 is formed via a single sheet of material, the chassis 300 can be manufactured quickly and efficiently. While such manufacturing may lead to tolerance variations (e.g., due to impreciseness of the folding locations), the other features of the modules 110, such as the pin structural supports 246 and socket connections 249, help to adjust and counter the tolerance issues that may be encountered with the manufacturing process.

The front chassis portion 320 provides the front panel 204 of the enclosure, which may be formed as a separate sheet metal piece and joined to the rear chassis 310 before or after installation of the electronics within. The front panel 204 may include one or more penetrations (or cutouts) 209 for one or more light indicator(s) and/or button(s)(e.g., an On/Off switch and/or an emergency power off button). The front chassis 320 may include one or more contoured portions to provide the recesses 224. A cover or lid (not shown) may be rigidly joined (e.g., screwed, glued, or welded) to the rear chassis 310 and front panel 320 to enclose the electronics within, forming the generally box-shaped module 200. While described here as formed of sheet metal, it will be understood that other suitable, non-metallic (e.g., any sufficiently rigid plastic or composite) material may be used for the chassis 300. In some embodiments, the rear, bottom, and side walls of the chassis 300 are substantially free of any penetrations 209 thereby rendering the chassis 300 substantially sealed further enabling the unit to be installed and operate outdoors. As previously described, when the modules 110 are assembled into a stack 101, the sides of the stack 101, including the front, rear and left and right sides, may all be substantially flush, providing the stack 101 with a substantially monolithic appearance. Air duct openings 203a and 203b are provided for at the top and bottom of each chassis 310,320 for the air duct that passes through the stack 101. Though additional examples of the system 100 or certain modules 110 may not include an air duct 203.

Additional, separately formed rectangular brackets may be joined to the chassis 300 to form the first and second vertical posts, 222 and 224 respectively. For example a first bracket 330 (see FIG. 14B), which has a front face 330-1 defining the aperture for a rear socket 249b, a side face 330-2 and top face 330-3, may be bolted (e.g., via flanges 330-4 and 330-5) to horizontal and vertical lips 311 and 313 of the rear chassis 310. Another bracket, mirror image of the bracket 330, may be similarly joined to the chassis at the opposite rear corner 315. A second bracket 340 (see FIG. 14C), which is wider than the first bracket 330, may be assembled to the chassis 300 at the lower left hand corner defined by panel segments 318 and 321, to provide second vertical post 224. The bracket 340 includes a rear face 340-1, which defines the various penetrations for the electrical connector and front socket 249a, as well as a side face 340-2 and a bottom face 340-3. The bracket 340 may be joined to the chassis 300, e.g., via bolting the flange 340-4 to the lip 319 of the chassis 300. A similar bracket, mirror image of the bracket 340, may be similarly joined to the other lower corner of the chassis, defined by the panel segments 317 and 322. Constructing the chassis 300 from multiple parts, for example as described with reference to FIGS. 14A-14C can enable the manufacturing of the modules 110 relatively cheaply and easily and may further facilitate ease of installation of the internal electrical components.

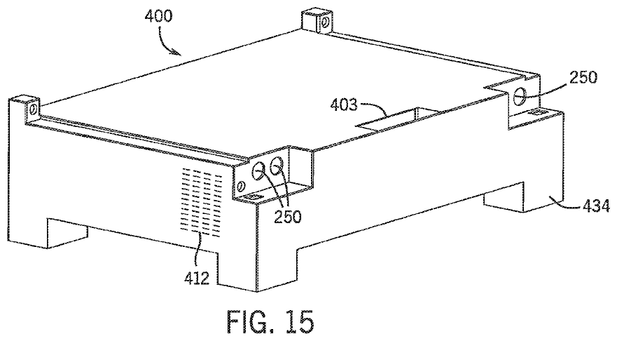

FIG. 15 shows the chassis 400 of a base module 110-1, illustrating that the base module 110-1 includes a coupling (or stacking) interface only on the top side of the module 110-1. The chassis 400 may include all or some of the features of the previously described modules 110 and 200 or the chassis 300. The top-side stacking interface of the base module 110-1 may be identical to the top-side stacking interface of any of the other modules 110 (e.g., module 200). As can be seen, the chassis 400 of a base module 110-1 includes at least one air duct opening 403 that connects to the air duct 203 formed in the stack 101 and at least one vent 412, preferably multiple such vents 412, to serve as air outlets for venting air to the exterior of the stack 101. The chassis 400 may further define the legs 412 of the base module 110-1. Depending on whether there are any electronics in the base module 110-1 and/or if any termination points for the communication/power buss are provided in the base module 110-1, the base module 110-1 may optionally include one or more connector penetrations 250 similar to the other modules 110.

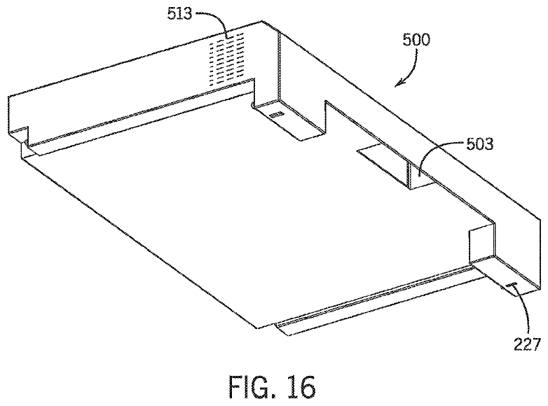

FIG. 16 shows the chassis 500 of a top module 110-3, illustrating that the top module 110-3 includes a coupling (or stacking) interface only on the underside of the module 110-3. On the underside, the chassis 500 includes a bottom-side stacking interface, which may be identical to the bottom-side stacking interface of any of the other modules 110 (e.g., module 200). Here again, a duct opening 503 is provided at a location aligned with the other duct openings of the air duct 203, and at least one, preferably a plurality of, vents 513, are provided to serve as air intake (or outlets, if the air flow is in the opposite direction from bottom to top). The top module 110-3 may further include a latch or latch release for the latching mechanism that may be actuated by the user. The latch or latch release may inhibit or allow the release of a lever 226 from the latch recesses 227 of each or some of the modules 110.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims. The foregoing description has broad application. The discussion of any embodiment is meant only to be explanatory and is not intended to suggest that the scope of the disclosure, including the claims, is limited to these examples. In other words, while illustrative embodiments of the disclosure have been described in detail herein, the inventive concepts may be otherwise variously embodied and employed, and the appended claims are intended to be construed to include such variations, except as limited by the prior art. It is to be understood that in instances where a range of values are provided that the range is intended to encompass not only the end point values of the range but also intermediate values of the range as explicitly being included within the range and varying by the last significant figure of the range. By way of example, a recited range from 1 to 4 is intended to include 1-2, 1-3, 2-4, 3-4, and 1-4.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure. All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings attached hereto may vary.

1. A modular energy storage system comprising:
a plurality of modules removably coupled into a stack and each including electrical components that together form the energy storage system, the plurality of modules comprising:
a lower module having a top side defining top alignment features;
an upper module having a bottom side defining bottom alignment features corresponding with the top alignment features to position the upper module on top of the lower module; and
wherein the upper module is stacked on the lower module and the upper and lower modules are electrically coupled.

2. The modular energy storage system of claim 1, wherein the upper and lower modules contain battery cells capable of storing and releasing electrical energy.

3. The modular energy storage system of claim 1, wherein the lower module further includes a vertically oriented lower electrical connection and the upper module further includes a vertically oriented upper electrical connection, the lower electrical connection coupling with the upper electrical connection.

4. The modular energy storage system of claim 3, wherein the upper and lower electrical connections are inaccessible from an exterior when the lower and upper modules are stacked.

5. The modular energy storage system of claim 3, wherein:
the upper module includes a post extending downward relative to the upper module, wherein the upper electrical connection is located on a side of the post;
the lower module defines a front recess in the top side, wherein the lower electrical connection is located on a wall of the front recess aligning with the side of the post; and
wherein the lower module receives the post of the upper module in the recess electrically coupling the upper module and lower module and preventing access to the upper electrical connection and the lower electrical connection.

6. The modular energy storage system of claim 1, wherein:
the top side includes a front recess in the top side and a rear post extending from the top side,
the bottom side includes a front post extending from the bottom side and a rear recess in the bottom side, and
wherein the top side of the lower module receives the bottom side of the upper module.

7. The modular energy storage system of claim 6, wherein:
one or more extending supports extend from the front recess and the rear recess,
one or more apertures are defined by the front post and the rear post, and
wherein the extending supports are received by the apertures and support a portion of the weight of the modular energy storage system.

8. The modular energy storage system of claim 1, the plurality of modules further comprising:
an intermediate module, having a second top side matching top alignment features of the lower module and a second bottom side matching the bottom alignment features of the upper module; and
wherein the intermediate module is inserted between the lower and upper module and electrically couples to the lower and upper module.

9. The modular energy storage system of claim 1, wherein the upper and lower modules comprise:
an external housing, and
a frame disposed within housing and supporting a weight of the modular energy storage system.

10. A modular energy storage system comprising:
a plurality of modules arranged into a stack, the plurality of modules comprising:
a lower module having a top side defining top alignment features;
an upper module having a bottom side defining bottom alignment features slidably and removably engaged with the top alignment features;
a plurality of battery cells and electrical components disposed within the upper and lower modules; and
wherein the upper module is slidably stacked on the lower module and the upper and lower modules are electrically coupled.

11. The modular energy storage system of claim 10, wherein:
the lower module further includes a lower electrical connection on a surface of the lower module from the top side and oriented perpendicular to the top side,
the upper module further includes an upper electrical connection on a surface extending from the bottom side and oriented perpendicular to the bottom side, and
wherein the lower electrical connection electrically couples with the upper electrical connection.

12. The modular energy storage system of claim 11, wherein the upper and lower electrical connections are inaccessible from an exterior when the lower and upper modules are stacked.

13. The modular energy storage system of claim 10, wherein:
the top alignment features comprise:
a channel defined in the top side of the lower module and extending across a portion of the top side,
a recess defined in the front side of the lower module, and
a post extending upwardly from a rear side of the lower module; and
the bottom alignment features comprise:
a rail extending from the bottom side of the upper module and configured to fit within the channel,
an extension defined by the front side of the upper module and configured to fit within the recess, and
a slot in the bottom side of the upper module and configured to receive the post.

14. The modular energy storage system of claim 12, wherein:
extending supports extend laterally from a wall of the recess and slot,
apertures are defined in the extension and post, and
wherein the extending supports are received in the apertures and together support a portion of the weight of the plurality of modules.

15. The modular energy storage system of claim 9, the plurality of modules further including:
an intermediate module, positioned between the upper and lower module and the intermediate module having a second top side configured to slidably engage with the bottom side of the upper module and a second bottom side configured to slidably engage with the top side of the lower module, and
wherein the intermediate module increases a total energy storage capacity of the modular energy system.

16. A modular energy storage system comprising:
a plurality of modules arranged into a stack, the plurality of modules comprising:
a lower module having a top side defining top alignment features;
an intermediate module including a bottom side defining bottom alignment features configured to slidably and removably engaged with the lower module;
an end module, different from the either or both of the lower module or intermediate module;
a plurality of electrical components disposed within the intermediate and lower modules; and
wherein the intermediate module slidably engages the lower module, electrically and mechanically coupling the intermediate and lower module.

17. The modular energy storage system of claim 15, the plurality of modules further comprising:
a top module having the bottom alignment features of the intermediate module and configured to be the highest module in the stack, and
wherein the top module is slidably placed on the intermediate module and electrically and mechanically coupling to the intermediate module.

18. The modular energy storage system of claim 15, wherein:
the top alignment features include a recess and a first electrical connection vertically oriented on a wall of the recess;
the bottom alignment feature include an extension and a second electrical connection vertically oriented on a wall of the extension; and
wherein the first electrical connection mates with the second electrical connection when the modules are slidably engaged.

19. The modular energy storage system of claim 15, wherein:
the top alignment features includes a channel extending along a length of the lower module,
the bottom alignment feature includes a rail extending along a length of the intermediate module and configured to fit in the channel, and
wherein the rail and channel guide the intermediate module in a first direction to an engagement position with the lower module and limits movement in a second direction transverse to the first direction.

20. The modular energy system of claim 15, wherein each of the plurality of modules comprise:
a rigid outer housing;
a frame within the housing to support the weight of the plurality of modules, the plurality of modules further comprising:
extensions oriented in a lateral direction and extending through the housing, and
apertures through the housing and configured to receive the extensions; and
wherein the frame of lower modules slidably couples with the support structure of the intermediate module.

21. The modular energy system of claim 15, wherein:
the top alignment feature includes a first latch portion,
the bottom alignment feature includes a second latch portion, and
where first latch portion mates with the second latch portion to limit movement of the plurality of modules relative to each other when slidably engaged.
